(19) United States
(12) Patent Application Publication
(10) Pub. No.: US 2026/0167471 A1
(43) Pub. Date: Jun. 18, 2026

(54) CONVEYANCE SYSTEM

(71) Applicant: TOYOTA JIDOSHA KABUSHIKI KAISHA, Aichi-ken (JP)

(72) Inventors: Yoji YAMAUCHI, Chuo-ku (JP); Zoltan BECK, Koto-ku (JP)

(73) Assignee: TOYOTA JIDOSHA KABUSHIKI KAISHA, Aichi-ken (JP)

(21) Appl. No.: 19/396,343

(22) Filed: Nov. 21, 2025

(30) Foreign Application Priority Data
Dec. 18, 2024 (JP) 2024-221358

(51) Int. Cl. B66F 9/075; B66F 17/00

(52) U.S. Cl. CPC B66F 9/0755; B66F 17/003

(57) ABSTRACT

Disclosed is a conveyance system configured to facilitate restoration of the system while preventing overrun of the mounting table. A conveyance system according to the present disclosure includes: a guide rail extending in a vertical direction; a mounting table engaged with the guide rail; a lifting unit configured to lift the mounting table up and down; a control unit configured to output a control signal for suppressing an operation of the lifting unit in the case where the mounting table has reached a position at a first height; and a safety control unit configured to cut off power supply from a power source to the lifting unit in the case where the mounting table has reached a position at a second height after reaching the position at the first height.

### CROSS REFERENCE TO RELATED APPLICATIONS

This application is based upon and claims the benefit of priority from Japanese patent application No. 2024-221358, filed on Dec. 18, 2024, the disclosure of which is incorporated herein in its entirety by reference.

### BACKGROUND

The present disclosure relates to a conveyance system.

Patent Literature 1 discloses a safety control unit configured to cut off the supply of energy to the lifting mechanism by detecting the overrun of a mounting table that is lifted up and down along a guide rail.

[Patent Literature 1] Japanese Unexamined Patent Application Publication No. Publication No. 2024-058735

### SUMMARY

In the case where the supply of energy to the lifting mechanism is physically cut off, there is a problem that it takes a long time to restore the system.

An object of the present disclosure is to provide a conveyance system including a mounting table, configured to facilitate restoration of the system while preventing overrun of the mounting table.

A conveyance system according to the present disclosure includes: a guide rail extending in a vertical direction; a mounting table engaged with the guide rail; a lifting unit configured to lift the mounting table up and down; a control unit configured to output a control signal for suppressing an operation of the lifting unit in the case where the mounting table has reached a position at a first height; and a safety control unit configured to cut off power supply from a power source to the lifting unit in the case where the mounting table has reached a position at a second height after reaching the position at the first height.

According to the present disclosure, it is possible to provide a conveyance system including a mounting table, configured to facilitate restoration of the system while preventing overrun of the mounting table.

The above and other objects, features and advantages of the present disclosure will become more fully understood from the detailed description given hereinbelow and the accompanying drawings.

### BRIEF DESCRIPTION OF DRAWINGS

FIG. 1 is a perspective view showing a schematic configuration of a conveyance robot according to a first embodiment;

FIG. 2 is a side view showing a schematic configuration of the conveyance robot according to the first embodiment;

FIG. 3 is a block diagram showing a functional configuration of the conveyance robot according to the first embodiment;

FIG. 4 is a front view showing a schematic configuration of a shelf according to the first embodiment; and

FIG. 5 is a view illustrating an operation of a limit switch according to the first embodiment.

### DESCRIPTION OF EMBODIMENTS

Specific embodiments to which the present disclosure is applied will be described in detail below with reference to the drawings. However, the present disclosure is not limited to the following embodiments. The following descriptions and drawings are simplified as appropriate for the sake of clarification of the explanation.

### First Embodiment

A conveyance system according to a first embodiment will be described below with reference to the drawings. The conveyance system includes a conveyance robot for conveying a package. The conveyance system may further include a server for managing the conveyance of the package by the conveyance robot. In this case, a part of the functions of the conveyance robot according to the first embodiment may be provided in the server. The conveyance system according to the first embodiment may also include a system in which the processing is completed in the conveyance robot. The conveyance system according to the first embodiment may further include a shelf on which the package is stored.

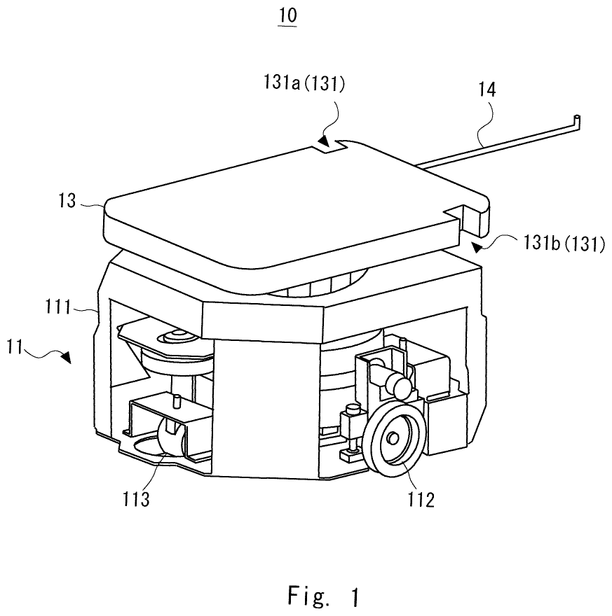

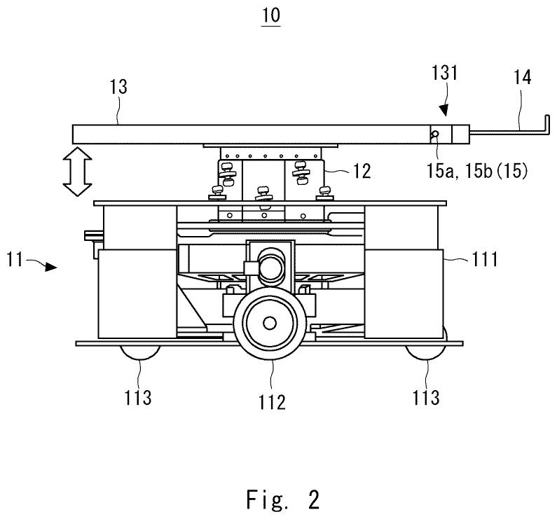

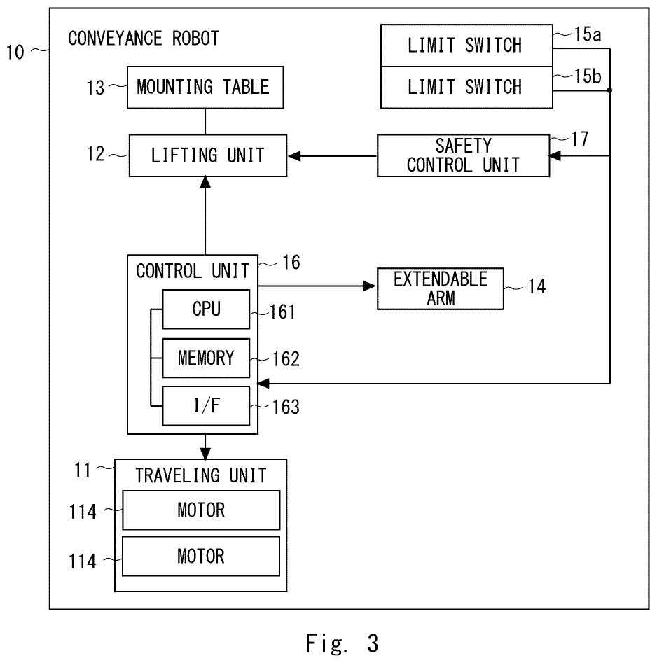

FIG. 1 is a perspective view showing a schematic configuration of a conveyance robot 10 according to the first embodiment. FIG. 2 is a side view showing a schematic configuration of the conveyance robot 10 according to the first embodiment. FIG. 3 is a block diagram showing the functional configuration of the conveyance robot 10 according to the first embodiment. The conveyance robot 10 includes a traveling unit 11 configured to be travelable, a lifting unit 12, a mounting table 13, an extendable arm 14, a pair of limit switches 15a and 15b, a control unit 16, and a safety control unit 17. The control unit 16 is configured to control the traveling unit 11, the lifting unit 12, and the extendable arm 14. The safety control unit 17 is configured to suppress operation of the lifting unit 12 based on the result of detection by the limit switches 15a and 15b.

The traveling unit 11 includes a main body 111 of a traveling part of the traveling unit 11 (hereinafter referred to as the traveling-part main body 111), a pair of right and left driving wheels 112 and a pair of front and rear driven wheels 113 rotatably provided on the traveling-part main body 111, and a pair of motors 114 for rotatably driving each driving wheel 112. Each motor 114 rotates each driving wheel 112 via a speed reducer or the like. Each motor 114 can cause the traveling-part main body 111 to travel to an arbitrary position by rotating each driving wheel 112 in response to a control signal from the control unit 16. The configuration of the traveling unit 11 is a mere example and is not limited thereto. For example, the number of the driving wheels 112 and the driven wheels 113 of the traveling unit 11 may be any number, and any configuration is applicable for the traveling unit as long as the traveling-part main body 111 can travel to an arbitrary position.

The lifting unit 12 is configured to lift the mounting table 13 up and down. The lifting unit 12 may be configured as a telescopic mechanism, for example.

The mounting table 13 is provided at the tip end of the lifting unit 12. The mounting table 13 is a table on which a package can be placed, and is also called a top plate. A pair of grooves 131a and 131b extending in the vertical direction are provided on the side surfaces of the mounting table 13. In the case where the grooves 131a and 131b that are in a pair are not distinguished from each other, they may simply be referred to as grooves 131. The pair of the grooves 131a and 131b are formed to pass from the lower surface to the upper surface of the mounting table 13. The pair of the grooves 131a and 131b are engageable to the pair of the guide rails 23a and 23b described later.

The extendable arm 14 is attached to the mounting table 13. The extendable arm 14 moves, for example, a hook attached to a guide rail mechanism (not shown) inside the mounting table 13 in the horizontal direction. The extendable arm 14 pushes a package placed on the mounting table 13 into a shelf 20 described below and pulls out a package stored in the shelf 20 onto the mounting table.

The limit switch 15a is provided to the groove 131a of the mounting table 13. The limit switch 15b is provided to the groove 131b of the mounting table 13. In the case where the limit switches 15a and 15b are not distinguished from each other, they may simply be referred to as the limit switch 15. The limit switch 15 includes, for example, a mechanically displaced actuator and a microswitch operated through the actuator. The limit switch 15 can detect, in the groove 131, the presence of a guide rail 23 described later.

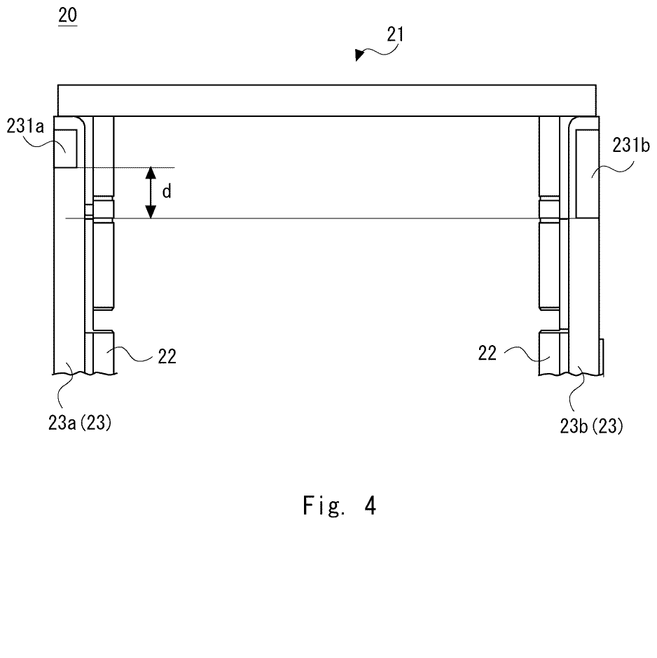

The shelf 20 engaged with the conveyance robot 10 according to the first embodiment will be described with reference to FIG. 4. FIG. 2 is a front view schematically showing the configuration of the shelf 20. In FIG. 1, illustration of the bottom side of the shelf 20 is omitted.

The shelf 20 includes a frame 21, a pair of support members 22, and the pair of the guide rails 23a and 23b. The frame 21 has, for example, a substantially rectangular frame shape when viewed from its front surface side, and the front surface of the frame 21 is opened.

A pair of the support members 22 extending in the depth direction is provided on the inner surface of the frame 21. A brim projecting from the side of a package (e.g., a returnable container), which is not shown, is placed on the pair of the support members 22. Although not shown in FIG. 1, a plurality of pairs of the support members 22 may be arranged at intervals in the top-bottom direction of the frame 21.

A pair of the guide rails 23a and 23b extending in the vertical direction is provided on the front surface of the frame 21. In the case where the guide rails 23a and 23b are not distinguished from each other, they may simply be referred to as the guide rail 23. The guide rail 23a is engaged with the groove 131a of the mounting table 13. The guide rail 23b is engaged with the groove 131b of the mounting table 13. In the case where the pair of the guide rails 23 is engaged with the pair of the grooves 131, the pair of the guide rails 23 is engaged with the mounting table 13. A gap for the conveyance robot 10 to enter in a state in which the mounting table 13 is lifted down may be formed between the lower surface of the frame 21 and the lower end of the pair of the guide rails 23.

The groove 231a is formed in the upper end of the guide rail 23a, and the groove 231b is formed in the upper end of the guide rail 23b. The grooves 231a and 231b are recessed, for example, in the depth direction of the shelf 20. The grooves 231a and 231b extend in the top-bottom direction. The height of the upper edge of the groove 231a is equal to the height of the upper edge of the groove 231b. The height of the lower edge of the groove 231a is higher than the height of the lower edge of the groove 231b. The distance d indicated by double-sided arrows indicates the difference between the height of the lower edge of the groove 231a and the height of the lower edge of the groove 231b. In the case where the mounting table 13 is lifted up to the upper end of the pair of the guide rails 23, the actuator of the limit switch 15a enters the groove 231a, and the actuator of the limit switch 15b enters the groove 231b.

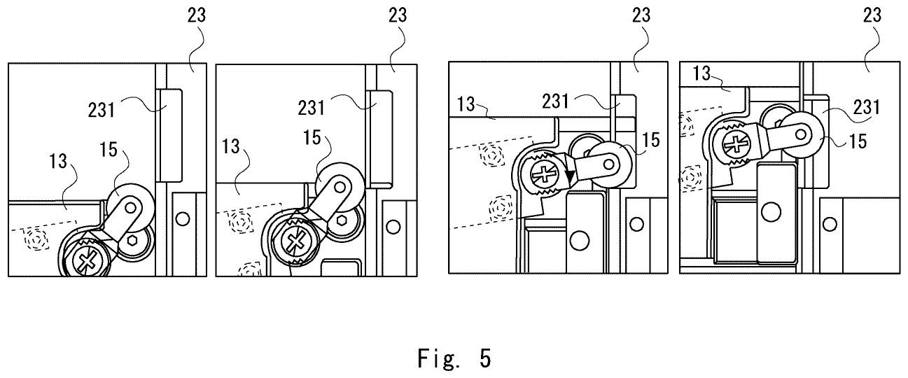

The operation of the limit switch 15 will be described with reference to FIG. 5. Referring first to the leftmost drawing in FIG. 5, the actuator of the limit switch 15 is located below the lower edge of the groove 231. At this time, the limit switch 15 is in the ON state. Subsequently, in the case where the mounting table 13 is lifted up, the actuator of the limit switch 15 reaches the lower edge of the groove 231, as shown in the second drawing from the left in FIG. 5. Subsequently, as shown in the third drawing from the left in FIG. 5, the actuator of the limit switch 15 enters the groove 231, and the limit switch 15 starts to switch from the ON state to the OFF state. Subsequently, as shown in the fourth drawing from the left in FIG. 5, the actuator of the limit switch 15 moves upward in the groove 231, and the state of the limit switch 15 changes to the OFF state.

Referring to FIG. 3, the control unit 16 may control the traveling of the conveyance robot 10 by performing well-known controls such as feedback control and robust control based on the rotation information of the drive wheels 112 detected by a rotation sensor provided in the drive wheels 112. The control unit 16 may cause the conveyance robot 10 to travel autonomously by controlling the traveling unit 11 based on the distance information detected by the distance sensor such as a camera or ultrasonic sensor installed in the conveyance robot 10 and information such as the map information of the environment in which the conveyance robot travels. The control unit 16 also supplies the control signals for controlling the lifting unit 12 and the extendable arm 14.

The control unit 16 has a hardware configuration centering on a microcomputer including, for example, a CPU161 (Central Processing Unit) for control processing, arithmetic processing, etc., a memory 162 consisting of a ROM (Read Only Memory) and a RAM (Random Access Memory) storing control programs and arithmetic programs executed by the CPU161, and an interface unit (I/F) 163 for input/output of signals to/from the outside. The CPU161, the memory 162, and the interface unit 163 are mutually connected via a data bus or the like.

The control unit 16 obtains the result of detection performed by the limit switches 15a and 15b. In the case where the state of the limit switch 15b is switched from the ON state to the OFF state, the control unit 16 outputs a control signal to the lifting unit 12 for suppressing operation of the lifting unit 12. The control signal may be a signal for setting a command value of the speed at which the mounting table is lifted up, for example, a command value of a speed of a motor included in the lifting unit 12, to zero. Alternatively, the control signal may be a signal for decelerating the speed at which the mounting table 13 is lifted up.

The distance d in FIG. 4 may be set to be larger than, for example, the sum of the product of the speed (e.g., maximum speed) of the mounting table 13 and the response time of the limit switch 15a and the distance traveled by the mounting table 13 from the output of the control signal by the control unit 16 to the stop of the mounting table 13.

The safety control unit 17 obtains the detection result by the pair of the limit switches 15a and 15b. In the case where the state of the limit switch 15a changes from the ON state to the OFF state and the state of the limit switch 15b changes from the ON state to the OFF state, the safety control unit 17 cuts off power supply from the power source to the lifting unit 12. Like the control unit 16, the safety control unit 17 may include a processor, a memory, or the like. The safety control unit 17 may be a PLC (Programmable Logic Controller). Specifically, the safety control unit 17 cuts off the supply of power to the lifting unit 12. For example, the safety control unit 17 may cut off the relay provided in the path for supplying power to the lifting unit 12. In the case where a driving source such as high-pressure air or oil is used instead of a power source, the safety control unit 17 may cut off the valve.

In the case where the mounting table 13 accidentally reaches the upper end of the pair of the guide rails 23a and 23b, the actuator of the limit switch 15b enters the groove 231b of the guide rail 23b, and the control unit 16 suppresses the operation of the lifting unit 12. In the case where the control unit 16 can suppress operation of the lifting unit 12, the safety control unit 17 does not operate, and the time required for the conveyance robot 10 to restore its operation can be reduced in the first embodiment.

In the case where the control unit 16 cannot suppress the operation of the lifting unit 12, the actuator of the limit switch 15a enters the groove 231a of the guide rail 23a, and the safety control unit 17 cuts off power supply from the power source to the lifting unit 12. Therefore, in the first embodiment, the lifting unit 12 can be safely stopped even if the control unit 16 fails. In the first embodiment, compared with the case where lifting-up of the mounting table 13 is mechanically stopped, the risk of scattering of the packages and damage to the mounting table 13 and the lifting unit 12 can be reduced.

It should be noted that the present disclosure is not limited to the above-described embodiment, and may be modified as appropriate without departing from the gist of the present disclosure.

For example, a pair of grooves 231a and 231b may be arranged side by side to one pair of the guide rails 23. In this case, one of the pair of the grooves 131 of the mounting table 13 have the pair of limit switches 15a and 15b arranged side by side. In addition, a pair of photo reflectors may be provided instead of the pair of the limit switches 15. In the upper end of the pair of the guide rails 23, a region where reflectance is high or a region where reflectance is low may be provided instead of the groove 231a and 231b. In addition, the grooves 231a and 231b may be detected by the pair of the photo reflectors.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A conveyance system comprising:
a guide rail extending in a vertical direction;
a mounting table engaged with the guide rail;
a lifting unit configured to lift the mounting table up and down;
a control unit configured to output a control signal for suppressing an operation of the lifting unit in the case where the mounting table has reached a position at a first height; and
a safety control unit configured to cut off power supply from a power source to the lifting unit in the case where the mounting table has reached a position at a second height after reaching the position at the first height.

2. The conveyance system according to claim 1, wherein
the mounting table is engaged with a first guide rail and a second guide rail,
the mounting table is provided with a first sensor corresponding to a first guide rail and a second sensor corresponding to a second guide rail,
the first sensor is configured to detect that the mounting table has reached the position at the first height, and
the second sensor is configured to detect that the mounting table has reached the position at the second height.

3. The conveyance system according to claim 2, wherein
the first guide rail has a first groove formed at a position falling in a height range from the first height to a predetermined height,
the second guide rail has a second groove formed at a position falling in a height range from the second height to the predetermined height,
the first sensor is configured to detect the first groove, and
the second sensor is configured to detect the second groove.

4. The conveyance system according to claim 3, wherein the first sensor and the second sensor are limit switches.

5. The conveyance system according to claim 4, wherein the safety control unit is configured to cut off power supply from the power source when an actuator of the limit switch serving as the first sensor enters the first groove and an actuator of the limit switch serving as the second sensor enters the second groove.
